(19) United States
(12) Patent Application Publication
(10) Pub. No.: US 2019/0071896 A1
(43) Pub. Date: Mar. 7, 2019

(54) LENGTH-ADJUSTABLE PUSH BAR EXIT DEVICE

(71) Applicant: Hampton Products International Corporation, Foothill Ranch, CA (US)

(72) Inventors: Jason L. Quinn, Spooner, WI (US); Lucas J. Stanton, Stone Lake, WI (US)

(73) Assignee: Hampton Products International Corporation, Foothill Ranch, CA (US)

(21) Appl. No.: 16/124,772

(22) Filed: Sep. 7, 2018

Related U.S. Application Data
(60) Provisional application No. 62/555,561, filed on Sep. 7, 2017.

(51) Int. Cl. E05B 65/10; E05B 63/24

(52) U.S. Cl. CPC E05B 65/1053; E05C 3/162; E05B 63/24

(57) ABSTRACT

A push bar exit device includes a longitudinal housing configured to be mounted on an inside surface of a door, the housing having an interior, a head end, and an open tail end. A length-adjustment tailpiece is slidably installed in the open tail end of the housing. The tailpiece may be slidable continuously within the housing to provide a continuous length adjustment, or it may be incrementally adjustably longitudinally by selective engagement with any of a plurality of detent pairs at discrete positions in the housing from the open tail end, whereby the tailpiece is movable incrementally into any of the discrete longitudinal positions defined by the detent pairs.

### CROSS-REFERENCE TO RELATED APPLICATION

This application claims the benefit, under 35 U.S.C. § 119(e), of U.S. Provisional Application No. 62/555,561, filed Sep. 7, 2017, the disclosure of which is incorporated herein by reference in its entirety, to the extent such disclosure is not inconsistent with disclosure expressly set forth herein.

### FEDERALLY SPONSORED RESEARCH OR DEVELOPMENT

Not Applicable.

### BACKGROUND

This disclosure relates to push bar exit devices for opening an exit door. Push bar exit devices are commonplace on the interior side of exit doors, in applications in which quick egress from a room or area is desired, especially if “hands-free” operation of the door-latching mechanism is desired. Typically, these devices comprise a longitudinal housing configured to be mounted on the interior surface of a door, and a push bar longitudinally mounted in the housing so as to be displaceable toward the interior of the housing by pushing against the exterior surface of the push bar. One end of the push bar is operatively connected by a latch actuation mechanism in the housing to a door latch that is movable between a latched position and an unlatched position. A pushing action against the push bar (i.e., to displace it inwardly into the interior of the housing) when the door is closed and the latch is in the latched position in a latch plate in the door jamb operates the latch actuation mechanism to move the latch to the unlatched position, withdrawn from the latch plate, allowing the door to be opened. Once the pushing action ceases, the push bar is biased back to its original by a spring mechanism in the housing, whereby the return of the push bar to its original position returns the latch to its latched position in which it can re-engage with the latch plate.

Push bar exit devices typically are made with housings in a limited number of standard lengths for standard door widths. Currently, for example, housings are provided in a 36 in. length that can be modified to fit doors with widths as small as 30 in., and a 48 in. length that can be modified to fit doors with widths as small as 37 in. Of course, either housing size will work on doors somewhat wider than the length of the housing, up to practical operational limits. Thus, doors having a width greater than perhaps 54 in. may require custom-made push bar exit devices.

It would therefore be desirable to provide a push bar exit device having a housing length that is suitable for mounting on doors of a wide variety of door widths; for example, 30-60 in.

### SUMMARY

In accordance with aspects of this disclosure, a length-adjustable push bar exit device includes a housing having a head end and an open tail end, and a length-adjustment tailpiece that is insertable into the open tail end of the housing so as to be movable longitudinally relative to the housing to allow the overall housing length to be selectively adjusted to fit operationally on a door having a width within a broad range. The tailpiece includes an insertion portion that slidably fits into the open tail end of the housing, whereby the tailpiece can be selectively set at a desired longitudinal position relative to the housing to adjust the overall length of the housing.

More specifically, a push bar exit device in accordance with aspects of this disclosure includes a hollow housing that is attachable to an interior surface the door, and that contains in its interior, near the head end, a latch actuation apparatus that is operatively linked to the latch. The housing is preferably configured so that, when mounted on an interior surface of a door, the tail end of the housing is a certain distance from the door jamb.

To provide an adjustment in the overall length of the housing, a length-adjustment tailpiece is slidably installed in the tail end of the housing. In some embodiments (which may be called “continuously adjustable” embodiments), the tailpiece can slide continuously, trombone-style, with a slight interference fit within the housing to provide a continuous length adjustment. For example, the tailpiece may be freely slidable within the housing with little or no gap between the tailpiece and the housing, so as to minimize lateral movement or “play” between the tailpiece and the housing. In other embodiments (which may be termed “detented” or “incrementally-adjustable” embodiments), the tail end of the housing is provided with indexed pairs of detents (e.g., apertures, slots, or indentations) that can be engaged by a pair of protuberances, preferably configured as tabs, on opposite sides of the insertion portion of the tailpiece. In the detented embodiments, the tailpiece extension can be inserted into the open tail end of the housing until the tabs or protuberances engage with the desired pair of detents to provide the desired overall length. In either the continuously-adjustable or the detented embodiments, a cover is preferably installed over the tail end of the housing and the tailpiece and fastened to a bracket at the end of the extension.

More specifically, in accordance with the detented embodiments, the tailpiece is movable incrementally into any of several discrete longitudinal positions within the housing, each of the positions corresponding to a selected length. Thus, in such embodiments, the insertion portion of the tailpiece comprises a pair of parallel side walls that fit into the open tail end of the housing, each of the side walls having an outwardly-projecting protuberance or tab. The housing is provided with a series of paired detents on opposite side walls of the housing, each of the detents being configured to receive one of the side wall protuberances. Each opposed pair of detents corresponds to an incremental detented position of the tailpiece relative to the housing. Thus, the tailpiece can be moved longitudinally within the housing until the tabs or protuberances engage with a selected pair of detents representing the desired longitudinal position of the tailpiece relative to the housing, whereby the selected longitudinal position corresponds to the desired overall housing length. Advantageously, the side walls can be pressed inwardly to disengage the tabs or protuberances from a first pair of detents, allowing the tailpiece to be moved to the desired position, at which point the side walls can return outwardly to bring the tabs or protuberances into engagement with a selected second pair of detents.

### BRIEF DESCRIPTION OF THE DRAWINGS

FIG. 1 is a perspective view showing the exterior (front) of a push bar exit device in accordance with aspects of the present disclosure.

FIG. 2 is a perspective view of the device of FIG. 1, showing the interior (back) of the device.

FIG. 3 is an exploded view of the device of FIG. 1.

FIG. 4 is a perspective view of a tailpiece in accordance with aspects of the disclosure.

FIG. 5 is a perspective view of the tailpiece of FIG. 4, showing the tailpiece of FIG. 4 installed in the housing of the push bar exit device of FIG. 1, in accordance with aspects of the present disclosure, the cover portion of the tailpiece being omitted for clarity.

FIG. 6 is a perspective view of similar to that of FIG. 5, showing the cover portion attached to the tailpiece.

### DETAILED DESCRIPTION

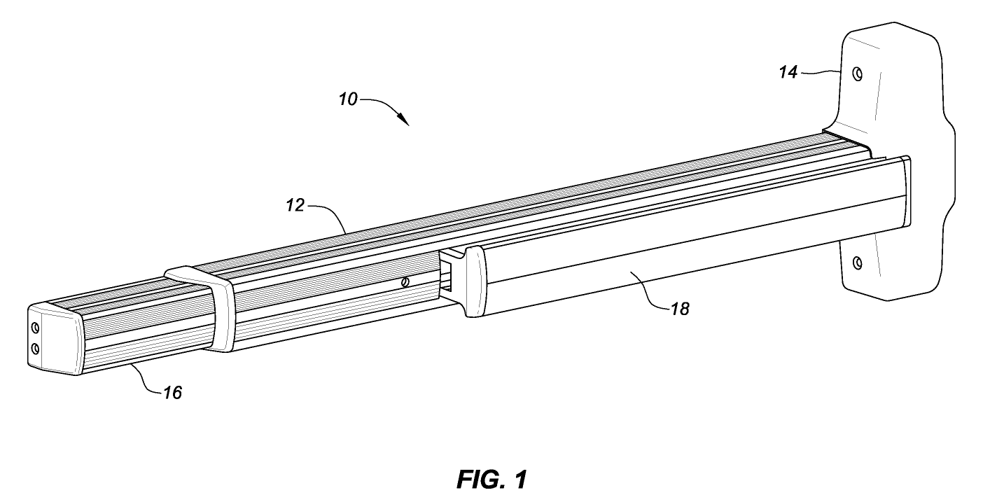

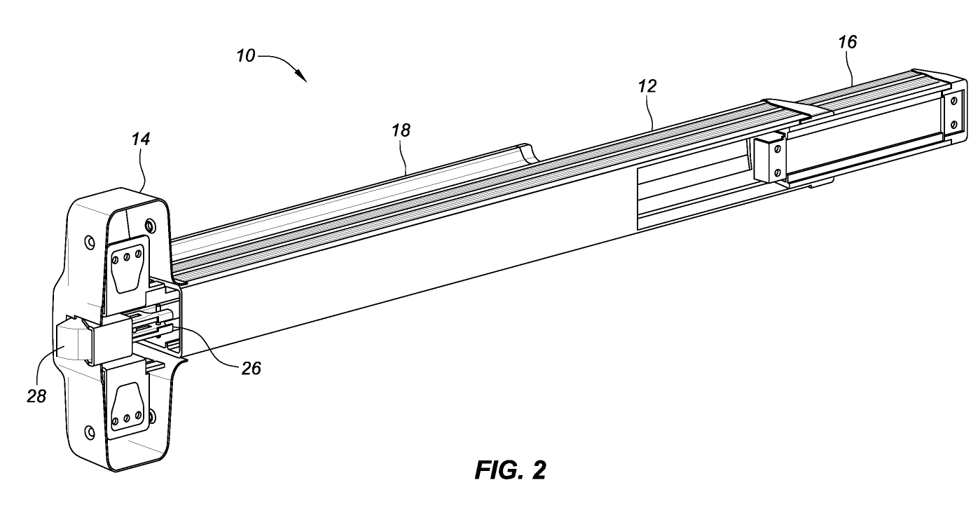

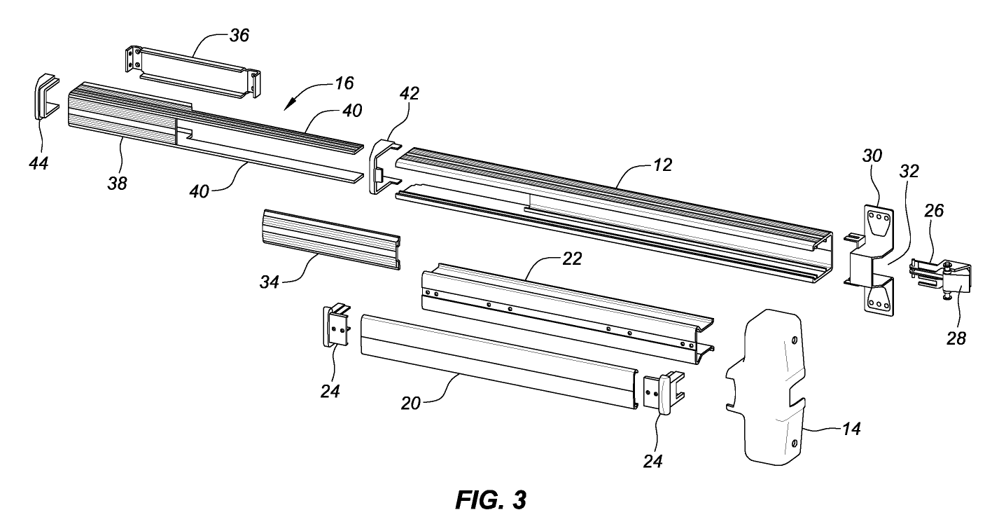

Referring first to FIGS. 1-3, a push bar exit device 10 in accordance with aspects of this disclosure is shown. The device 10 is configured to be mounted on the inside surface of an exit door (not shown). The device 10 includes a hollow housing 12 having a head end covered by a head cover 14, and a tail end that is open to receive a length-adjustment tailpiece 16, to be described in detail below. The housing 12 has an interior and an open front or exterior side (see FIG. 3) dimensioned to receive a spring-loaded push bar 18. As shown in FIG. 3, as is typical in convention push bar exit devices, the push bar 18 may comprise a cover portion 20 secured to a rail portion 22 by a pair of end brackets 24. The push bar 18 is connected, by a conventional latch actuation mechanism 26 (partially shown in FIG. 2), to a door latch 28 installed in the head end of the housing 12, within the head cover 14. A first mounting bracket 30 may be contained in the head cover 14 for attachment of the device 10 to a door (not shown), as mentioned above. The first mounting bracket 30 is advantageously configured with a central channel 32 that accommodates the latch 28. A sliding shim 34 may advantageously be installed in the housing 12 between the push bar 18 and the tail end of the housing.

Conventionally, the push bar 18 is installed in the housing 12 so as to be biased (as by spring-loading) toward a first or outward position relative to the housing, in which the latch actuation mechanism 26 is in a latch-engaged condition, such that the latch 28 is in a latched position in which it is engaged with a latch plate (not shown) in a door jamb (not shown). In response to a pushing force against its outer surface or cover portion 20, the push bar 18 is displaced to a second or inward position relative to the housing 12, thereby operating the latch actuation mechanism 26 to move to a latch-disengaged condition, moving the latch 28 to an unlatched position in which it is disengaged from the latch plate, thereby allowing the door (not shown) to be opened.

As mentioned above, the housing 12 has a tail end opposite the head end (to which the head cover 14 is attached). The tail end of the housing 12 is open and configured to receive the tailpiece 16. As shown in FIGS. 2 and 3, a second mounting bracket 36 is advantageously fixed to the inside (door-facing side) of the tailpiece 16 for securing the device 10 to the door (after the tailpiece 16 is adjusted to the desired position, as described below) in conjunction with the above-mentioned first mounting bracket 30. As shown in FIG. 3, the tailpiece 16 has an end portion that includes a tailpiece cover 38, and an insertion portion configured to be inserted into the open tail end of the housing 12. In some embodiments, particularly continuously-adjustable embodiments, the insertion portion may advantageously comprise a pair of parallel rods or rails 40 dimensioned for insertion into the hollow interior of the housing 12 through its open tail end (which may optionally be framed with a housing end cap 42). The covered end portion of the tailpiece 16 may likewise be configured and dimensioned to be slidably insertable into the open tail end of the housing 12, as shown in FIGS. 1-3. Alternatively, the tailpiece cover 38 may be configured to fit over the tail end of the housing 12, as shown in FIG. 6. The terminal end of the tailpiece 16 may optionally be fitted with a tailpiece end cap 44. The tailpiece end cap 44 can be fixed to an end of the second mounting bracket 36 to fix the tailpiece 16 at the desired position and secure the tail end of the housing 12 of the exit device 10 to the door.

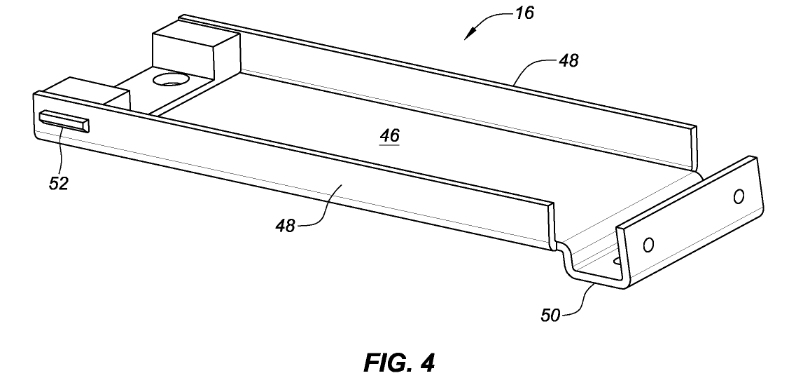

Details of the end portion of an exemplary incrementally-adjustable embodiment of the length-adjustment tailpiece 16 and its operative engagement with the tail end of the housing 12 are shown in FIGS. 4-6. In this embodiment, the tailpiece may lack the insertion rails 40 described above with reference to continuously adjustable embodiments and shown in FIG. 3. As shown in FIG. 4, the tailpiece 16 has a main body 46 configured as a shallow channel member with relatively low parallel side walls 48. The main body 46 has a first or insertion end configured to be slidably insertable into the open tail end of the housing 12. A second or mounting end of the main body 46 of the tailpiece 16 is configured as a mounting element 50 to which the tailpiece cover 38 and the second mounting bracket 36 may be secured.

A protuberance or tab 52 is provided on the outwardly-facing surface of each of the side walls 48 at or near the insertion end of the tailpiece 16. (Only one such tab 52 is shown in the drawings; the other tab would be preferably located the same distance from the insertion end.) The shape and relative size of the tabs 52 shown in the drawings are exemplary only; any suitable shape and size may be selected. Furthermore, while the tabs 52 may be formed integrally with the side walls 48, they may be separate elements that are suitably affixed to the side walls, by whatever means are suitable for the materials involved. It should be noted that some incrementally-adjustable embodiments may have insertion rails 40 (as shown in FIG. 3, for example); if so, the tabs 52 would be fixed to the rails 40 at the appropriate locations.

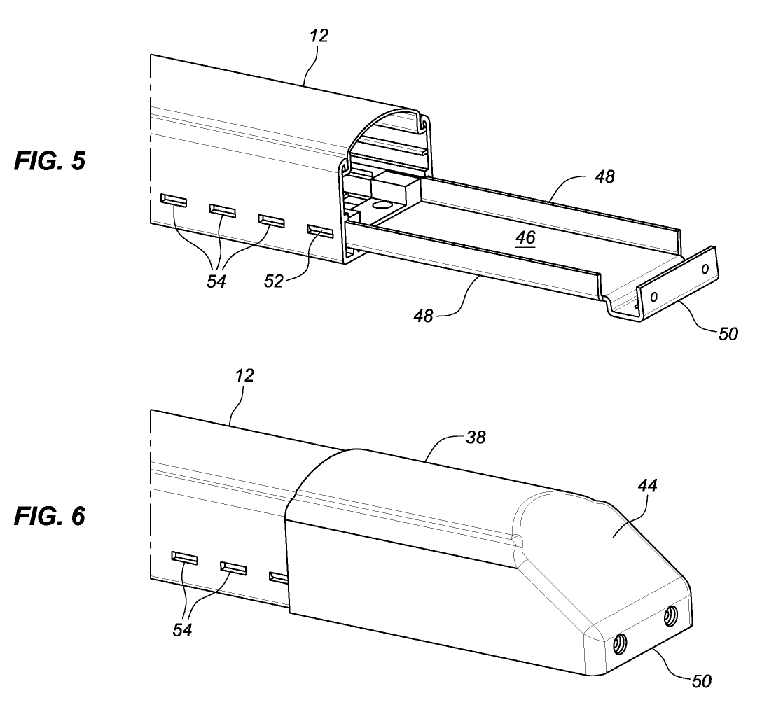

As shown in FIGS. 5 and 6, the tail end of the housing 12 is provided with a linear array of detents, shown in the illustrated exemplary embodiment as apertures or slots 54, in each side of the housing at discrete indexed positions from the open tail end of the housing 12. While the detent array in only one side of the housing is shown, it will be understood that a matching detent array is provided on the opposite side of the housing, thereby providing a linear series of opposed detent pairs 54, with each detent pair defining a discrete indexed position from the open tail end of the housing 12. The apertures or slots 54 are configured and dimensioned to receive the tabs 52. Thus, as shown in FIGS. 5 and 6, the apertures 54 are elongate, slot-like openings to receive the narrow, elongate tabs 52 shown in the drawings, but these shapes are exemplary only. Furthermore, instead of the apertures or slots 54, the detents in the sides of the tail end of the housing 12 can be configured as linear arrays of indentations or dimples (not shown) dimensioned to receive the tabs 52. The opposed detent pairs 54 may be spaced at predetermined increments along the length of the housing, e.g., increments of one inch or a half inch; or increments of one, two, or three centimeters. The incrementally-spaced detent pairs 54 provide incrementally spaced and predefined detented longitudinal positions for the tailpiece 16 relative to the housing 12.

In one manner of use, the head end of the housing 12 is mounted to an interior door surface using the first mounting bracket 30. The insertion portion of the tailpiece 16 is inserted into the open tail end of the housing 12 to a selected longitudinal position within the housing that corresponds to the desired overall length of the housing and tailpiece. The tailpiece 16 is then secured to the door in this position using the second mounting bracket 36.

In using the incrementally-adjustable embodiment of FIGS. 4-6, the insertion portion of the tailpiece 16 is inserted into the open tail end of the housing 12 until the tabs 52 are aligned with a pair of detents (e.g., apertures or slots 54) that define a position of the tailpiece 16 relative to the housing that corresponds to the desired overall length of the push bar exit device 10. The insertion and movement of the tailpiece 16 within the interior of the housing may require some flexing of the sidewalls 48 toward each other. Thus, it may be advantageous to form the tailpiece 16 as a flexible, resilient element that permits such flexing, with a resilient return to a non-flexed condition when the tabs 52 are aligned with the apertures 54. If the tailpiece embodiment having the rails 40 (shown in FIG. 3) is used, the rails themselves may be made resiliently flexible. Thus, by engaging the tabs 52 with a selected opposed pair of apertures or slots 54 (or indentations), the overall length of the device 10 may be incrementally adjusted among any of the predefined detented positions, as described above.

While the above-described detented, incremental length adjustment feature will be preferred in many applications, it is possible that some users may prefer (or some applications may require) a continuous adjustment feature, wherein there are no predefined detented positions for the tailpiece relative to the housing. In such continuously-adjustable embodiments, the detent features (i.e., the tabs 52 and the detent apertures or slots 54) are omitted, and the side walls 48 (FIGS. 4 and 5) or rails 40 (FIG. 3) of the tailpiece 16 are slidable within the housing 16 with a friction fit. In such embodiments, the desired tailpiece position, once achieved, can be set with set screws (not shown) inserted through threaded apertures (not shown) in each housing side to engage the side walls of the tailpiece.

In any embodiment, the overall length of the device housing 12 can be adjusted for use on doors of a wide variety or widths. The length adjustment is advantageously made by manipulating the tailpiece 16 relative to the housing 12, as described above, to attain the desired overall length, and then mounting the entire device to the inside surface of an exit door using the mounting first and second brackets described above.

In FIG. 6, the tailpiece cover 38 is shown as attached to the tailpiece 16, secured to the mounting element 50. In the illustrated embodiment, the cover 38 is dimensioned to slide over the tail end of the housing 12, preferably with a slight friction fit. The tailpiece end cap 44 shown in FIG. 16 is formed integrally with the tailpiece cover 38. Alternatively, the tailpiece cover 38 and the tailpiece end cap 44 may be separate elements, as shown in FIG. 3.

The embodiments and aspects described herein and illustrated in the drawings are exemplary only. Modifications, variations, equivalents, and adaptations of these embodiments and aspects that may suggest themselves to those skilled in the pertinent arts should be considered within the spirit and scope of the disclosure.

What is claimed is:

1. A push bar exit device, comprising:
a longitudinal housing configured to be mounted on an inside surface of a door, the housing having an interior, a head end, and an open tail end;
a latch at the head end of the housing and movable between a latched position and an unlatched position
a latch actuation mechanism in the interior of the housing and operatively linked to the latch so as to move the latch between the latched position and the unlatched position;
a push bar longitudinally mounted in the housing so as to be displaceable toward the interior of the housing, the push bar being operatively connected to the latch actuation mechanism so that displacement of the push bar toward the interior of the housing operates the latch actuation mechanism to move the latch from the latched position to the unlatched position; and
a length-adjustment tailpiece slidably installed in the open tail end of the housing.

2. The push bar exit device of claim 1, wherein the tailpiece is slidable continuously within the housing to provide a continuous length adjustment.

3. The push bar exit device of claim 1, wherein the tailpiece comprises a parallel pair of rails configured for insertion into the open tail end of the housing.

4. The push bar exit device of claim 1, further comprising a linear array of detents in each side of the housing at discrete indexed positions from the open tail end of the housing, thereby providing a linear series of opposed detent pairs, each detent pair defining a discrete indexed longitudinal position from the open tail end of the housing, each of the opposed detent pairs being configured to be engaged by a pair of protuberances on opposite sides of the tailpiece when the tailpiece is slidably installed in the open tail end of the housing, whereby the tailpiece is movable incrementally into any of the discrete longitudinal positions defined by the detent pairs.

5. The push bar exit device of claim 4, wherein the tailpiece comprises a pair of parallel side walls, each of the side walls including one of the pair of protuberances.

6. A method of adjusting the overall length of a push bar exit device, comprising:
providing an exit device housing having a head end and an open tail end;
fixing the head end of the housing to an interior door surface;
providing a tailpiece having an insertion portion configured for slidable insertion into the open tail end of the housing;
inserting the insertion portion of the tailpiece into the open tail end of the housing;
adjusting the tailpiece longitudinally within the housing to a selected longitudinal position corresponding to a desired overall length; and
fixing the tailpiece to the interior door surface.

7. The method of claim 6, wherein the selected longitudinal position is one of a plurality of detented positions.

8. The method of claim 6, where the step of adjusting the tailpiece comprises sliding the tailpiece continuously within the housing to the selected longitudinal position.

9. A length-adjustment tailpiece for a push bar exit device including a housing having an open tail end, the tailpiece comprising:
an insertion portion configured to be inserted into the open tail end of the housing so as to be longitudinally movable therein to a longitudinal position corresponding to a desired length.

10. The length-adjustment tailpiece of claim 9, wherein the insertion portion includes a pair of opposed protuberances configured to engage a selected detent pair of a plurality of incrementally-spaced detent pairs in the housing, each of the detent pairs defining one of a plurality of selectable longitudinal positions.
